(19) United States
(12) Patent Application Publication
(10) Pub. No.: US 2026/0100033 A1
(43) Pub. Date: Apr. 9, 2026

(54) ELEVATION DETERMINATION SYSTEM

(71) Applicant: CoreLogic Solutions, LLC, Irvine, CA (US)

(72) Inventors: Taylor Bryant Brown, Euless, TX (US); Logan Parker, New York, NY (US)

(21) Appl. No.: 19/345,859

(22) Filed: Sep. 30, 2025

Related U.S. Application Data
(60) Provisional application No. 63/703,863, filed on Oct. 4, 2024.
(60) Provisional application No. 63/802,430, filed on May 8, 2025.

(51) Int. Cl. G06V 20/17; G06T 7/13; G06T 7/521; G06T 7/55; G06T 15/20; G06V 10/26; G06V 10/75; G06V 10/764; G06V 20/70

(52) U.S. Cl. CPC G06V 20/17; G06T 7/13; G06T 7/521; G06T 7/55; G06T 15/205; G06V 10/26; G06V 10/751; G06V 10/764; G06V 20/70; G06T 2200/24; G06T 2207/10028; G06T 2207/10032; G06T 2207/30184

(57) ABSTRACT

A system may receive image information associated with a property. The system may apply the image information as input to a machine learning model configured to semantically segment the image information according to identified features. The system may identify an occupied portion of the structure based on at least the semantic segmentation image information. The system may determine elevation information for the occupied portion of the structure based on the image information. The system may store or otherwise use the determined elevation information.

### CROSS-REFERENCE TO RELATED APPLICATIONS

This application claims priority under 35 U.S.C. § 119(e) to U.S. Provisional Application No. 63/703863, filed Oct. 4, 2024, and titled “ELEVATION DETERMINATION SYSTEM,” and U.S. Provisional Application No. 63/802430, filed May 8, 2025, and titled “ELEVATION DETERMINATION SYSTEM,” which are hereby incorporated by reference herein in their entirety.

### BACKGROUND

Measuring devices including surveying equipment may be used to determine the elevation and grade of land around a structure on a property. Measurements of the structure, and knowledge of the lowest occupied floor of the structure, can be used to determine the elevation of the lowest occupied floor of the structure. The lowest occupied floor of the structure may be used to determine a flood risk of the structure.

### SUMMARY

In some aspects, the techniques described herein relate to a computer-implemented method including: receiving depth information associated with a property captured by a first sensor type, wherein the property includes a structure; receiving image information associated with the property captured by a second sensor type; applying the image information as input to a machine learning model to cause the machine learning model to generate semantic segmentation image information, wherein the machine learning model is configured to perform semantic segmentation on image information; identifying an occupied portion of the structure based on the semantic segmentation image information; determining elevation information for the occupied portion of the structure based on the depth information and the image information; and storing the elevation information.

The method of the preceding paragraph can include any sub-combination of the following features: where the first sensor type and the second sensor type are different; where the first sensor type is at least one of a LIDAR sensor or a time of flight sensor, and where the second sensor type is an image sensor; where the occupied portion is a lowest occupied portion of the structure, and where the computer-implemented method further includes identifying the lowest occupied portion of the structure based on at least the image information; generating graphical user interface information including the elevation information, and transmitting the graphical user interface information to cause display of the elevation information; where the graphical user interface information further includes at least a portion of the image information, and where transmitting the graphical user interface information further causes display of the portion of the image information; generating a three-dimensional image of the structure, where the three-dimensional image includes a label indicating the elevation information for the occupied portion of the structure, where the graphical user interface information includes a view of the three-dimensional image including the label, and where transmitting the graphical user interface information further causes display of the view of the three-dimensional image; determining second elevation information for a second portion of the structure based on the depth information and the image information, and associating the second elevation information with a second portion of the structure, where the three-dimensional image further includes a second label indicating the second elevation information for the second portion of the structure, and wherein the second label is hidden in the view; receiving, via a graphical user interface, a user input rotating the three-dimensional image, and updating the graphical user interface to display a second view of the three-dimensional image, where the second label is visible in the second view; where determining the elevation information includes identifying a depth portion of the depth information associated with the occupied portion, identifying a second depth portion of the depth information associated with a ground area nearest to the occupied portion, and determining a height difference between the depth portion and the second depth portion, where the height difference indicates an elevation of the occupied portion relative to the ground area; identifying a lowest occupied portion of the structure based on the semantic segmentation image information, where the occupied portion is the lowest occupied portion; accessing a flood risk assessment form, and completing at least a portion of the flood risk assessment form based on the elevation information; accessing historical water level information associated with the property, where the historical water level information includes a previously recorded water level, determining the previously recorded water level exceeds an elevation indicated by the elevation information, and in response to determining the previously recorded water level exceeds the elevation, transmitting an alert; accessing a water level prediction, determining the water level prediction exceeds an elevation indicated by the elevation information, and transmitting an alert to an emergency response service.

In some aspects, the techniques described herein relate to a system including: a computer-readable memory; and one or more processors in communication with the memory, wherein computer-executable instructions, when executed by the one or more processors, causes the one or more processors to at least: receive depth information associated with a property captured by a first sensor type, wherein the property includes a structure; receive image information associated with the property captured by a second sensor type; apply the image information as input to a machine learning model to cause the machine learning model to generate semantic segmentation image information, wherein the machine learning model is configured to perform semantic segmentation on image information; identify an occupied portion of the structure based on the semantic segmentation image information; determine elevation information for the occupied portion of the structure based on the depth information and the image information; and store the elevation information.

The system of the preceding paragraph can include any sub-combination of the following features: where the second sensor type is a camera, and where the system further includes the camera; where the first sensor type is a LIDAR sensor, and wherein the system further includes the LIDAR sensor; where to store the elevation information the computer-executable instructions, when executed, further cause the one or more processors to transmit the elevation information to a property information data store; where the occupied portion of the structure is not currently occupied.

In some aspects, the techniques described herein relate to a non-transitory, computer-readable medium encoded with computer-executable instructions executable by a processor of a computing device, wherein the computer-executable instructions, when executed by the processor, cause the computing device to: receive depth information associated with a property captured by a first sensor type, wherein the property includes a structure; receive image information associated with the property captured by a second sensor type; apply the image information as input to a machine learning model to cause the machine learning model to generate semantic segmentation image information, wherein the machine learning model is configured to perform semantic segmentation on image information; identify an occupied portion of the structure based on the semantic segmentation image information; determine elevation information for the occupied portion of the structure based on the depth information and the image information; and store the elevation information.

In some aspects, the techniques described herein relate to a computer-implemented method including: accessing aerial image information comprising an aerial image associated with a property; applying the aerial image as input to a machine learning model to cause the machine learning model to generate semantic segmentation image information, wherein the machine learning model is configured to perform semantic segmentation on image information; identifying an occupied portion of a structure located on the property based on the semantic segmentation image information; determining elevation information for the occupied portion of the structure based on an element of the structure identified in the semantic segmentation image information and the aerial image information; and storing the elevation information.

The method of the preceding paragraph may include any sub-combination of the following features: where the aerial image information includes a plurality of aerial images, and where the computer-implemented method further includes: selecting, from the aerial image information, the aerial image based on the aerial image comprising a view of at least a portion of the structure; wherein the aerial image information includes a plurality of aerial images, and wherein the computer-implemented method further includes identifying a set of aerial images from the plurality of aerial images comprising a view of at least a portion of the structure, selecting the aerial image from the set of aerial images based on a first view of the structure in the aerial image, selecting a second aerial image from the set of aerial images based on a second view of the structure in the second aerial image, wherein the second view is different from the first view, applying the second aerial image as input to a machine learning model to cause the machine learning model to generate second semantic segmentation image information, wherein the machine learning model is configured to perform semantic segmentation on image information, determining second elevation information for the occupied portion of the structure based on a second element of the structure identified in the second semantic segmentation image information, and determining that the elevation information is more likely to be correct than the second elevation information; where determining that the elevation information is more likely to be correct than the second elevation information includes determining an element type of the element, determining a second element type of the second element, and comparing the element type and the second element type to a hierarchy of element types to determine the element type is associated with a higher confidence than the second element type; where the first view is associated with a first cardinal direction, and where selecting the second aerial image from the set of aerial images is further based on the second view being associated with a second cardinal direction different than the first cardinal direction; where the aerial image information comprises camera information associated with each image of the plurality of images, and where a direction of the first view is determined based on the camera information; where the camera information comprises at least one of: degree of freedom information associated with a camera used to generate the aerial image at a time the aerial image was generated, or location information for an aerial vehicle used to generate the aerial image at the time the aerial image was generated; where wherein the semantic segmentation image information comprises identification of the element as associated with a first element type, where the semantic segmentation information comprises identification of a second element associated with a second element type, and where the computer-implemented method further includes comparing the first element type and the second element type to a hierarchy of element types to determine the first element type is preferred for use in determining elevation information; where the semantic segmentation image information comprises identification of the element as associated with a first element type, where the semantic segmentation information comprises identification of a second element as associated with a second element type, where the first element type is the same element type as the second element type, and where the computer-implemented method further includes determining a first elevation of a lowest edge of the first element, determining a second elevation of a lowest edge of the second element, comparing the first elevation to the second elevation to determine the first elevation is lower than the second elevation, and based on the first elevation being lower than the second elevation, selecting the element for use in determining elevation information for the occupied portion of the structure; where the semantic segmentation image information comprises identification of the element as associated with a first element type, where the semantic segmentation information comprises identification of a second element as associated with a second element type, where the first element type is the same element type as the second element type, and wherein the computer-implemented method further includes: determining a first elevation of a lowest edge of the first element, determining a second elevation of a lowest edge of the second element, comparing the first elevation to the second elevation to determine the first elevation is higher than the second elevation, and based on the first elevation being higher than the second elevation, selecting the element for use in determining elevation information for the occupied portion of the structure.

In some aspects, the techniques described herein relate to a system including a computer-readable memory, and one or more processors in communication with the memory, wherein computer-executable instructions, when executed by the one or more processors, causes the one or more processors to at least: access aerial image information comprising an aerial image associated with a property, apply the aerial image as input to a machine learning model to cause the machine learning model to generate semantic segmentation image information, wherein the machine learning model is configured to perform semantic segmentation on image information, identify an occupied portion of a structure located on the property based on the semantic segmentation image information, determine elevation information for the occupied portion of the structure based on an element of the structure identified in the semantic segmentation image information and the aerial image information, and store the elevation information.

The system of the preceding paragraph may include any sub-combination of the following features: where the aerial image information comprises a plurality of aerial images, and where the computer-executable instructions, when executed, further cause the one or more processors to at least select, from the aerial image information, the aerial image based on the aerial image comprising a view of at least a portion of the structure; where the aerial image information comprises a plurality of aerial images, and where the computer-executable instructions, when executed, further cause the one or more processors to at least: identify a set of aerial images from the plurality of aerial images comprising a view of at least a portion of the structure, select the aerial image from the set of aerial images based on a first view of the structure in the aerial image, select a second aerial image from the set of aerial images based on a second view of the structure in the second aerial image, wherein the second view is different from the first view, apply the second aerial image as input to a machine learning model to cause the machine learning model to generate second semantic segmentation image information, wherein the machine learning model is configured to perform semantic segmentation on image information, determine second elevation information for the occupied portion of the structure based on a second element of the structure identified in the second semantic segmentation image information, and determine that the elevation information is more likely to be correct than the second elevation information; determine an element type of the element, determine a second element type of the second element, and compare the element type and the second element type to a hierarchy of element types to determine the element type is associated with a higher confidence than the second element type; where the first view is associated with a first cardinal direction, and where selecting the second aerial image from the set of aerial images is further based on the second view being associated with a second cardinal direction different than the first cardinal direction; where the aerial image information comprises camera information associated with each image of the plurality of images, and wherein a direction of the first view is determined based on the camera information; where the camera information comprises at least one of: degree of freedom information associated with a camera used to generate the aerial image at a time the aerial image was generated, or location information for an aerial vehicle used to generate the aerial image at the time the aerial image was generated; where the semantic segmentation image information comprises identification of the element as associated with a first element type, where the semantic segmentation information includes identification of a second element associated with a second element type, and wherein the computer-executable instructions, when executed, further cause the one or more processors to at least compare the first element type and the second element type to a hierarchy of element types to determine the first element type is preferred for use in determining elevation information; where the semantic segmentation image information includes identification of the element as associated with a first element type, where the semantic segmentation information comprises identification of a second element as associated with a second element type, where the first element type is the same element type as the second element type, and where the computer-executable instructions, when executed, further cause the one or more processors to at least: determine a first elevation of a lowest edge of the first element, determine a second elevation of a lowest edge of the second element, compare the first elevation to the second elevation to determine the first elevation is lower than the second elevation, and based on the first elevation being lower than the second elevation, select the element for use in determining elevation information for the occupied portion of the structure; where the semantic segmentation image information comprises identification of the element as associated with a first element type, where the semantic segmentation information comprises identification of a second element as associated with a second element type, where the first element type is the same element type as the second element type, and where the computer-executable instructions, when executed, further cause the one or more processors to at least: determine a first elevation of a lowest edge of the first element, determine a second elevation of a lowest edge of the second element, compare the first elevation to the second elevation to determine the first elevation is higher than the second elevation, and based on the first elevation being higher than the second elevation, select the element for use in determining elevation information for the occupied portion of the structure.

In some aspects, the techniques described herein relate to a computer-implemented method including: receiving image information associated with a property, applying the image information as input to a machine learning model to cause the machine learning model to generate semantic segmentation image information, wherein the machine learning model is configured to perform semantic segmentation on image information, identifying an occupied portion of a structure associated with the property based on the semantic segmentation image information, determining elevation information for the occupied portion of the structure based on the image information, and storing the elevation information.

The method of the preceding paragraph may include any sub-combination of the following features: where the image information is aerial image information comprising an aerial image associated with the property, where the computer-implemented method further comprises accessing the aerial image information, where the image information is captured by a first sensor type, where determining the elevation information is further based on depth information, and receiving the depth information associated with the property captured by a second sensor type.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIG. 1 is a block diagram of an illustrative environment for providing flood risk assessment according to some embodiments.

FIG. 2 is a block diagram of illustrative data flows within a system for providing a flood risk assessment based on information captured by a mobile computing device according to some embodiments.

FIG. 3 is a flow diagram of an illustrative routine for determining elevation information as part of a flood risk assessment according to some embodiments.

FIG. 4 is a flow diagram of an illustrative routine for determining elevation information for a structure on a property from aerial imagery according to some embodiments.

FIG. 5 is a flow diagram of an illustrative routine for determining elevation information according to some embodiments.

FIG. 6 is an illustrative example of a structure for which elevation information may be determined by a flood risk assessment system according to some embodiments.

FIG. 7 is a block diagram of an illustrative computing system configured to provide a flood risk assessment according to some embodiments.

### DETAILED DESCRIPTION

The present disclosure relates to determining the elevation of a portion of a structure located on a property. The present disclosure further relates to using the determined elevation information as part of a flood risk assessment.

Some conventional systems allow for the determination of the elevation of a structure. The information used to determine the elevation may be generated by a LIDAR device. For example, a LIDAR device may be attached to the underside of an aerial vehicle (e.g., helicopter, airplane, drone, etc.). The aerial vehicle may then be directed to fly over an area where the property is located and collect elevation information for the area using the attached LIDAR device. Elevation information for the structure may be useful in assessing a flood risk for the property, for example based on an elevation of an occupied portion of the structure relative to a lowest adjacent grade. Flood risk determination is a process that is highly sensitive to local changes in grade surrounding a structure, and existing methods of determining elevation for an occupied portion of a structure relative to a lowest adjacent grade may include inaccuracies that lead to improper flood risk determination, harming home owners and affecting the ability to plan for long-term costs of repair.

However, capturing elevation information using an aerial LIDAR system presents several problems. For example, LIDAR measurements may not be able to penetrate vegetation, structural overhangs (e.g., a roof, an awning, etc.), structures nearby a structure of interest for an elevation determination, or other objects situated between the aerial vehicle and the ground or structure. Additionally, the angle at which an overhead LIDAR measurement is taken may affect the ability to determine elevation information for portions of the structure. For example, capturing LIDAR information for a lower portion of the structure may be difficult using an aircraft, as other portions of the structure may obstruct the view of the LIDAR device. Further, the use of aerial vehicles to capture LIDAR information for an area may be time-consuming and resource intensive. In the case where a portion of the captured LIDAR information is missing or otherwise not usable, it may not be determined that a portion of the LIDAR information is missing or not useable until the aerial vehicle has already landed. In such a case, the aerial vehicle may then have to be set up to make an additional flight to capture the missing LIDAR information. Even where it is determined during flight that a portion of the LIDAR information is missing or otherwise not usable, the aerial vehicle may not be able to capture the missing information. For example, for an airplane, a flight path may need to be cleared prior to the flight and alterations may not be possible during flight. Further, even if redirecting an aerial vehicle during flight is legally possible, the aerial vehicle may not have sufficient fuel or electric charge to perform an additional flyover of the property.

Alternatively, the information used to determine the elevation may be generated by surveying the property and the structure using surveying equipment. For example, a team of qualified surveyors may bring surveying equipment to the property. The surveying equipment may then be used to capture property information including a local elevation for a portion of the property, a distance to a point on a structure, and an angle to the point on the structure. The information captured by the surveying team may then be used to mathematically determine the elevation of various portions of the property and the structure. However, the use of surveying equipment to determine the elevation of a portion of a structure may present various problems. For example, finding a qualified surveyor with surveying equipment may be challenging in remote locations, limiting the ability of a property owner to accurately determine a flood risk for such locations. Additionally, work may be performed on a property that alters a grade or elevation of the ground surrounding a structure. A team of surveyors may then be required to return to the property to update a previous flood risk assessment, leading to delays or other challenges with accurately preparing for a flood or updating flood insurance.

In another alternative, the information used to determine the elevation may be generated based on an image of the structure, for example a ground level view of the structure generated for use in association with a map. In some cases, images of the structure may be captured for the purpose of assessing an elevation or flood risk. Alternatively, an image may be accessed from an online database (e.g., a multiple listing service) and used to perform an elevation determination or flood risk assessment. For example, images may be accessed until relevant views of a structure on the property are obtained. Photogrammetry may then be used to determine the elevation measurements for the structure, and the measurements may be compared to existing elevation data for the area to determine elevation information for portions of the structure. However, using photogrammetry on a ground level view represented in an image may present various problems when attempting to accurately determine elevation information or perform a flood risk assessment.

For example, changes in lighting, angles, or the device capturing the images may cause errors in the determined measurements when images are not captured at a similar time or are retrieved from different image providers. Images may also not be associated with additional information about the image capture device used to generate the image, limiting the ability of a user to correct for, or otherwise account for, differences between imaging systems (e.g., image sensor types, camera position or direction, etc.). Additionally, when historical images (e.g., images accessed from an online database) are used the information determined from the historical images may no longer be accurate. Further, ground level views of a structure may be obstructed by various objects including, for example, landscaping (e.g., trees, shrubs, planters, raised planting beds, etc.), vehicles, appliances (e.g., an air conditioner), and the like. Ground level views of the structure may additionally be limited information about all portions of a structure. For example, access to at least a portion of a property may be restricted (e.g., based on a fence, water feature, or object limiting access to that portion of the property) and so some portions of the structure may not be represented in images. Therefore, ground level view images, such as those accessed from a multiple listing service, may not be able to provide sufficient information about a property to accurately determine the elevation of an occupied portion of the structure thereby reducing the ability of a user to accurately assess a flood risk for the structure.

Some aspects of the present disclosure address some or all of the issues noted above, among others, by providing a system for determining elevation information for a structure on a property. The system may guide a user in capturing image information or depth information for a structure on a property. The depth information may be captured, for example, using a depth information capture unit of a mobile computing device. The depth information may include positional information (e.g., GPS coordinates) for the mobile device, and the positional information may be used with the depth information to more accurately determine elevation information. The system may use a machine learning model to semantically segment the image information and generate semantically segmented image information. As used herein, semantically segmented image information may refer to image information associated with information indicating the identity of one or more objects identified as being represented in the image information. For example, the semantically segmented image information may be labelled or associated with metadata to indicate the identity or presence of objects represented in the image information. The system may use the depth information, the image information, or the semantically segmented image information, alone or in combination, to identify the lowest occupied floor of the structure, or another portion of the structure for which elevation information will be determined. The system may use the depth information, the image information, or the semantically segmented image information, alone or in combination, to determine the elevation of the lowest occupied floor of the structure, or the elevation of the portion of the structure that is indicated to be of interest.

Some aspects of the present disclosure address some or all of the issues noted above, among others, by providing a system for determining elevation information for a structure on a property based on aerial imagery. The system of the present disclosure may access a plurality of aerial images from an aerial image data source (e.g., a database of aerial images, an aerial image capture device, etc.) and identify aerial images that contain at least a partial view of a structure to be assessed. In some embodiments, the system may identify a set of aerial images from the available plurality of aerial images representing different views of the structure. For example, the system may select views associated with different cardinal directions (e.g., N, NE, S, SSW, etc.). In some embodiments, four views may be selected such that each view is separated by substantially 90 degrees from two other views (e.g., a north-facing view, south-face view, east-facing view, and west-facing view may be selected for the four views). In alternative embodiments, different numbers of views may be selected, and the views may be selected to maximize the degree of distance between each neighboring view. For example, if three views are used, then the views may be selected such that each view is substantially 120 degrees from each neighboring view.

When referring to a view being substantially a number of degrees from another view, it should be understood that while a goal may be to have each view at the number of degrees separation from another view, such precision may not be possible based on the available aerial imagery. As such, the system of the present disclosure may select an aerial image having a view that is the closest to the degree offset that is desired from the available aerial imagery. For example, if three views are used, a first and second view may be offset by 120 degrees, but a third view may be offset from the first view by 100 degrees, and from the second view by 140 degrees, due to the third view being the closest available view to the preferred 120 degree offset represented by the available aerial images.

The system of the present disclosure may semantically segment aerial images using a machine learning model trained to generate semantic segmentation image information. The semantic segmentation image information may label elements of the structure that are represented within the aerial image information of an aerial image. The system may determine a height relative to ground level for at least one element identified in the semantic segmentation image information. Determining the height may be based on additional information in the aerial image information, or associated with the aerial image information. The aerial image information may include metadata, or be associated with additional information, that indicates information related to the image sensor, camera device, or aerial vehicle used to generate the aerial image information. Such information may include, for example, a location of the aerial vehicle when the aerial image was generated, degree of freedom information (e.g., pitch, yaw, roll, surge, sway, or heave) for a camera used to generate the aerial image, an image sensor type, a resolution of the image, a time the aerial image was generated, compass information for the aerial vehicle or camera, and the like. The semantic segmentation image information may be used to identify elements (e.g., a wall, a door, a porch railing, a porch, a pier post, an air conditioner, a vent, etc.) of the structure in the aerial image information. The location of an element in the aerial image information may then be used to determine the elevation of the element. In some embodiments, the lowest edge, or highest edge, of an element may be used to determine the elevation of the element.

In some embodiments, certain elements of a structure may be preferred for use in determining the elevation of a first occupied portion of the structure. The elements may be ranked, for example in a hierarchy, based on the preference for use in determining the elevation. For example, a hierarchy of elements may indicate that, from most preferred to least preferred, a pier post, a door, a window, and a porch railing, may be used to determine the elevation of the first occupied portion of the structure. Where two of the same type of element are identified as being present on the structure, a preference may be given to the element having the highest elevation, or an element having the lowest elevation. Further, the selection of a preferred element for use in determining elevation information may be based at least in part on a foundation type of the structure. For example, foundation type information may be accessed or determined for the structure, and based on the foundation type a different hierarchy, or a different preferred element, may be used to determine the elevation of the occupied portion of the structure.

In further embodiments, the system of the present disclosure may generate a visualization based on the aerial image information. For example, the system may generate a 3-dimensional (3D) model of the structure based on the aerial images. The aerial image information used to generate a visualization may be different from the aerial image information used to determine the elevation of the occupied portion of the structure. For example, a set of eight aerial images may be used to determine the occupied portion of the structure based on including different viewpoints. Then, in order to include additional detail in the 3D model of the structure, additional aerial images associated with the property may be accessed. Further, the visualization may be based at least in part on the semantic segmentation image information generated from an aerial image. For example, a 3D model of a structure may identify elements of the structure (e.g., a door, window, air conditioner, dryer vent, porch, porch railing, pier post, wall, etc.) such that a user may determine the element type of the identified element from the 3D model.

The above-described aspects of the present disclosure provide various advantages over conventional systems, as will be discussed now. One advantage of the present disclosure over the previously described conventional systems is that a user may more efficiently obtain elevation information for a structure, as the use of an aerial vehicle or surveying equipment is not needed to perform an elevation determination. Another advantage of the present disclosure is that determining elevation information for a structure does not rely on historical information (e.g., previously-captured images) where the historical information may be out of date. A further advantage of the present disclosure is that a more accurate elevation determination may be provided for properties with obstructions present (e.g., vegetation, additional structures, etc.), as a user handling a mobile device may have access to areas not viewable in historical images, or in LIDAR information or aerial images captured from an aerial vehicle. Additionally, by reducing or eliminating the need for specialized equipment not typically present in a mobile device, areas with reduced or no accessibility for such specialized equipment may still be evaluated for elevation information and flood risk.

Additionally, the present disclosure allows for determining elevation information as part of another system or process. For example, a real estate agent may be capturing images for use in generating a property listing as part of preparing the property for sale. During the image capture process, the agent may be instructed to additionally capture images useful for determining elevation information. In another example, a home inspector may be capturing images to generate a home inspection report, and elements of the present disclosure may be employed to allow for determining elevation information for the home as part of the overall inspection.

Further, although the use of an image capture process at the property to determine elevation information and the use of aerial images to determine elevation information are described separately, each process may be at least partially combined to provide a more accurate assessment of the elevation of the occupied portion of the structure. For example, access to a portion of the structure may be restricted to a real estate agent or other user on the ground, and aerial image information may then be used to supplement the user-generated image information. In another example, elevation information determined from user-generated image information and aerial image information separately may be compared to determine a possibility of error in the determination of the elevation of the occupied portion of the structure. Such a combined process may advantageously allow for improved accuracy in the determination of elevation of the occupied portion of the structure, and may provide redundancy when image information for at least a portion of the structure is not available, or otherwise unusable (e.g., due to obstruction, lighting, or other issues present when generating the image).

The above-described systems and processes of the present disclosure enable determination of elevation for the occupied portion of a structure may be more accurate than existing systems. The use of aerial image information allows for minimization of the effect of obstructions on the property in determining the elevation relative to a lowest adjacent grade over existing image-based or LIDAR-based systems. For example, the ability to select an aerial image from multiple available aerial images may allow for selection of aerial images where the effect of obstructions is reduced (e.g., because the structure is more visible from certain views). Additionally, camera-based aerial imaging systems are generally more available to users than LIDAR-based solutions, expanding access to the elevation determination of the present disclosure thereby improving the ability of users to prepare for and mitigate flood risk. Further, the use of images captured by a mobile device with a LIDAR sensor, or aerial images, allows for improved accuracy of elevation determination over existing systems that use ground-based image information from a publicly available map database. Additionally, image information and semantic segmentation image information generated as described in the present disclosure may be more readily combinable with additional data sources, such as digital elevation models, allowing integration with outside data sources to improve the accuracy of determination of elevation information and flood risk.

The term “model,” as used in the present disclosure, can include any computer-based models of any type and of any level of complexity, such as any type of sequential, functional, or concurrent model. Models can further include various types of computational models, such as, for example, artificial neural networks (“NN”), transformer-based models (e.g., GPT models), language models (e.g., large language models (“LLMs”)), artificial intelligence (“AI”) models, machine learning (“ML”) models, multimodal models (e.g., models or combinations of models that can accept inputs of multiple modalities, such as images and text), and/or the like.

While certain aspects and implementations are discussed herein with reference to use of a transformer-based model, and/or AI, those aspects and implementations may be performed by any other transformer-based model, language model LLM, AI model, generative AI model, generative model, ML model, NN, multimodal model, and/or other algorithmic processes. Similarly, while certain aspects and implementations are discussed herein with reference to use of a ML model, those aspects and implementations may be performed by any other AI model, generative AI model, generative model, NN, multimodal model, and/or other algorithmic processes.

In various implementations, the LLMs and/or other models (including ML models) of the present disclosure may be locally hosted, cloud managed, accessed via one or more Application Programming Interfaces (“APIs”), and/or any combination of the foregoing and/or the like. Additionally, in various implementations, the transformer-based models and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Various aspects of the disclosure will be described with regard to certain examples and embodiments, which are intended to illustrate but not limit the disclosure. Although aspects of some embodiments described in the disclosure will focus, for the purpose of illustration, on particular examples of property types, sensor types, and the like, the examples are illustrative only and are not intended to be limiting. In some embodiments, the techniques described herein may be applied to additional or alternative types of property types, sensor types, and the like. Additionally, any feature used in any embodiment described herein may be used in any combination with any other feature or in any other embodiment, without limitation.

### Example Floor Height Assessment Environment

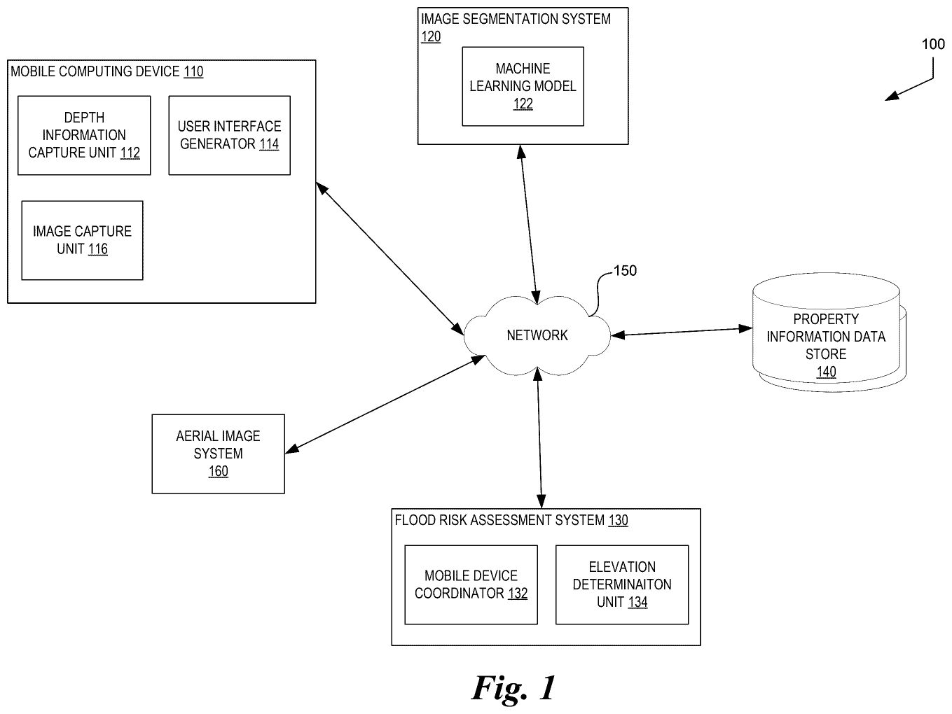

With reference to an illustrative example, FIG. 1 shows an example environment 100 for assessing a floor height of a structure on a property. Determining the floor height of the first floor may be used, for example, as part of determining a flood risk for the structure, or the property. The environment 100 includes a mobile computing device 110, an image segmentation system 120, a flood risk assessment system 130, a property information data store 140, a network 150, and an aerial image system 160.

The flood risk assessment system 130 is a computing system for performing a flood risk assessment of a property based on a determined floor height for a structure on the property. The flood risk assessment system 130 includes a mobile device coordinator 132 and an elevation determination unit 134.

The mobile device coordinator 132 coordinates interactions between the flood risk assessment system 130 and a mobile computing device 110 that is being used to capture image or depth information for a property. The mobile device coordinator 132 may receive a request to perform a floor height determination or flood risk assessment from a mobile computing device 110. The mobile device coordinator 132 may provide user interface information to the mobile computing device 110 to guide a user through the process of capturing image information or depth information for a property, or to allow the user to provide any additional information (e.g., location information) the flood risk assessment system 130 may use to determine a floor height or complete a flood risk assessment. Further, the mobile device coordinator 132 may coordinate the use of two or more mobile devices 110 to capture or provide information used by the flood risk assessment system 130 to assess a flood risk. For example, a first mobile computing device 110 may be a smartphone with an image capture unit 116 but that does not have a depth information capture unit 112. In this example a second mobile computing device 110 may be a portable LIDAR device. The mobile device coordinator 132 may coordinate the capture of image information and depth information using the first mobile computing device 110 and the second mobile computing device 110 by providing instructions to a user of the mobile devices. The instructions may direct the user in how to capture depth information and image information using the two mobile devices for the same portions of a structure so that the elevation determination unit 134 may determine a floor height for the structure (e.g., via a GUI providing image directions to the user).

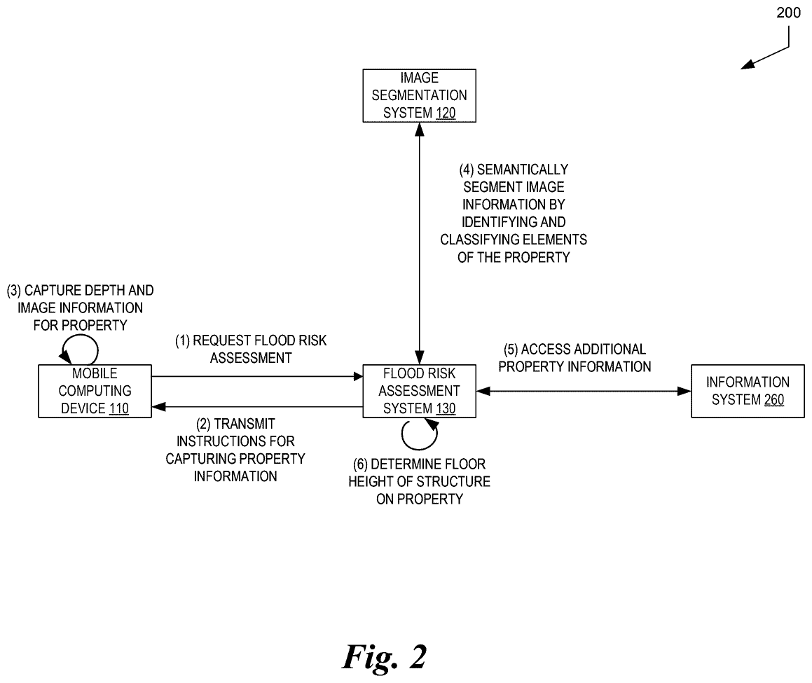

The elevation determination unit 134 determines the height of a floor of a structure on a property. The elevation determination unit 134 may determine elevation information for at least a portion of a structure on a property. The elevation information may be determined based on the depth information (e.g., generated by the depth information capture unit 112) and at least one of the image information (e.g., generated by the image capture unit 116, accessed from a property information data store 140, etc.), or the semantically segmented image information (e.g., received from the image segmentation system 120). For example, where the elevation information for the first floor of a structure is to be determined, the elevation determination unit 134 may access a portion of the depth information associated with the first floor. In this example, the elevation determination unit 134 may access the semantically segmented image information to identify the portion of the depth information associated with the first floor. In some embodiments, the elevation determination unit 134 may additionally determine the first occupied floor of the structure. As used herein, occupied does not necessarily refer to a current occupation and instead refers to the ability of a human to occupy the area generally (e.g., entering the area, sitting in the area, sleeping in the area, etc.), whether or not a human is currently occupying the area. The first occupied floor may be determined based on the semantically segmented image information. The elevation determination unit 134 may use a rules-based, or machine learning, approach to analyze the semantically segmented image information and identify features likely to indicate occupancy. Examples of features likely to indicate occupancy include, for example, a window, a window through which furniture or people can be observed, an entrance (e.g., a garage door, a sliding door, a hinged door etc.), a vent (e.g., a stove vent, a dryer vent, an air vent, etc.), and the like. The elevation determination unit 134 may implement various portions of the floor height determination process 200, routine 300, or routine 400 described below with respect to FIGS. 2-4.

The mobile computing device 110 may be, for example, a smartphone, a laptop computing device, or the like. The mobile computing device 110 includes a depth information capture unit 112, a user interface generator 114, and an image capture unit 116. The mobile computing device 110 may be associated with a user. The user may interact with the flood risk assessment system 130 through the mobile computing device 110. For example, a display of the mobile computing device 110 may provide an interactive graphical user interface (GUI) generated by the user interface generator 114 to the user for interacting with the flood risk assessment system 130. The user interface generator 114 may receive instructions for providing the GUI from the mobile device coordinator 132 of the flood risk assessment system 130.

The depth information capture unit 112 is capable of capturing depth information used by the flood risk assessment system 130 to assess a flood risk or determine a floor height for a structure. The depth information capture unit 112 may be, for example, a LIDAR system, a structured light camera, or any system capable of capturing depth information. The depth information generated by the depth information capture unit 112 represents the three-dimensional structure of an object or area. The depth information may be stored, for example, as a point cloud or mesh. In some embodiments, the depth information capture unit 112 may capture the depth information as a point cloud, and the mobile computing device 110 or the flood risk assessment system 130 may perform interpolation to generate a mesh.

The user interface generator 114 is configured to generate an interactive GUI for a user of the mobile computing device 110. The user interface generator 114 may provide display information to cause the mobile computing device 110 to display the GUI. Additionally, the user interface generator 114 may receive input information from the user. The input information may be used by the user interface generator 114 to update the GUI, for example based on a user selecting a menu option. The user interface generator 114 may also provide the input information to the mobile device coordinator 132 of the flood risk assessment system 130 to allow the user to interact with the flood risk assessment system 130.

The image capture unit 116 captures image information used by the flood risk assessment system 130 to generate a floor height determination or flood risk assessment. The image capture unit 116 may, for example, be a camera system (e.g., a lens and a CMOS sensor) capable of recording still or continuous images of an area.

In some embodiments, a plurality of mobile computing devices may be used to perform various functions of the mobile computing device 110. For example, a first mobile computing device 110 may be a smartphone including a display to present a user interface generated by the user interface generator 114, and a camera to act as the image capture unit 116. In this example a second mobile computing device 110, for example a quadcopter or other drone, may include a depth information capture unit 112 (e.g., a LIDAR unit) used to capture depth information for the property.

The image segmentation system 120 is a computing system configured to divide image information into a set of image segments. The image segmentation system 120 receives image information to be divided from the flood risk assessment system 130. The image information may be the image information captured by the image capture unit 116 of the mobile computing device 110, aerial image information from the aerial image system 160, or image information retrieved from the property information data store 140. The image segmentation system 120 may use a machine learning model 122, or other computer vision system, to analyze the image information and generate the set of image segments. The segments of the set of image segments may be generated based on features in the image information identified by the image segmentation system 120. For example, a feature identified by the image segmentation system 120 may include an opening of a structure (e.g., a window, a door, a vent, etc.), a foundation of the structure, a stilt or other supporting element of the structure, any other portion of the structure, a plant (e.g., a hedge, a bush, a garden, etc.), a second structure, or any additional object on the property including those which may obstruct the structure in the image information.

The property information data store 140 may be part of a computing system used to store property information for one or more properties. For example, the property information data store 140 may be a data store of a Multiple Listing Service, a private real estate information database, a government property information database, and the like. Property information stored by the property information data store 140 may include an image of at least a portion of a property, an aerial image of an area where the property is located, a flood map, a topographical map, a prior flood risk assessment, location information, insurance information, or other information that may be useful in determining a floor height or performing a flood risk assessment for a property.

The network 150 may be a publicly-accessible network of linked networks, some or all of which may be operated by various distinct parties, for example the Internet. In some cases, network 150 may include a private network, personal area network, local area network, wide area network, cellular data network, satellite network, etc., or some combination thereof, some or all of which may or may not have access to and/or from the Internet.

The aerial image system 160 may be a device, or system, used to generate or store aerial images. An aerial image may include image information generated by a camera in an elevated position relative to a property, or a structure on a property, being imaged. An aerial image may be associated with metadata, or other information, associated with a camera or device (e.g., an imaging device) used to generate the aerial image. For example, the metadata, or other information associated with the aerial image, may indicate a location of the imaging device, an elevation of the imaging device, information related to at least one degree of freedom of an image sensor (e.g., information for at least one of six degrees of freedom including surge, heave, sway, pitch, roll, or yaw), a color range of an image sensor, a field of view of an image sensor, a lens type, a length of exposure of an image, or other information associated with the image sensor or imaging device generally.

### Example Floor Height Determination Process

FIG. 2 illustrates example data flows implementing a floor height determination process 200. The process 200 begins at (1) where the flood risk assessment system 130 receives a request to perform a flood risk assessment from a mobile computing device 110. The request may include, for example, location information for a property, location information for a structure on the property, user information for a user requesting the flood risk assessment, or other information related to the initiation of a flood risk assessment. The location information may be based on a GPS unit of the mobile device 110, cellular tower triangulation, nearby Wi-Fi networks, or information entered into the mobile computing device 110 by the user.

At (2), the flood risk assessment system 130 transmits instructions for capturing property information to the mobile computing device 110. The mobile device coordinator 132 may transmit user interface information to cause the user interface generator 114 to generate a user interface for a user of the mobile computing device 110. The user interface may provide a set of instructions to the user, guiding the user through the process of capturing, entering, or generating the property information used by the flood risk assessment system 130 to determine a floor height for a structure on the property. The set of instructions may include an image, a video, audio, or text. For example, the request from the user may indicate the user wants to determine the first floor height of a house located on a property. The mobile device coordinator 132 may then transmit user interface information to the user interface generator 114 including a video to be displayed by the mobile computing device 110 showing the user how to use the depth information capture unit 112 to capture the depth information used by the flood risk assessment system 130 to determine the first floor height. The user interface information of this example may then cause the mobile computing device 110 to show the user a visual indication of how much of the depth information has been captured, and further instructions for capturing any missing depth information (e.g., an arrow directing the user to move the mobile computing device 110 in a particular direction). The user interface information of this example may then instruct the user in capturing image information for the property using the image capture unit 116 by directing the user to capture image information for the portion of the property the user captured depth information for. The user interface generator 114, or the mobile device coordinator 132, may ensure that the user captures the image information based on location information associated with the captured depth information to ensure that the space captured in the image information substantially overlaps with the depth information.

At (3), the user of the mobile computing device 110 captures depth information and image information for at least a portion of the property. The depth information and image information may, for example, be captured for the portion of the property where a structure is located. The depth information may be captured by the user using the depth information capture unit 112 of the mobile computing device 110. The image information may be captured by the user using the image capture unit 116 of the mobile computing device 110. The image information may be captured by the user based on following the instructions provided by the flood risk assessment system 130. Further, the depth information may be captured by the user based on following the instructions provided by the flood risk assessment system 130. The depth information and image information captured by the mobile computing device 110 may be transmitted to the flood risk assessment system 130. The depth information may be transmitted separately from the image information.

For example, the user may first capture the image information for the property. The mobile computing device 110 may then transmit the image information to the flood risk assessment system 130 as the image information is captured (e.g., following the capture of each image, following the capture of all images, etc.). The mobile computing device 110 may capture the depth information following capturing the image information. The mobile computing device 110 may then transmit the depth information to the flood risk assessment system 130 (e.g., following capture of a portion of the depth information, or all of the depth information).

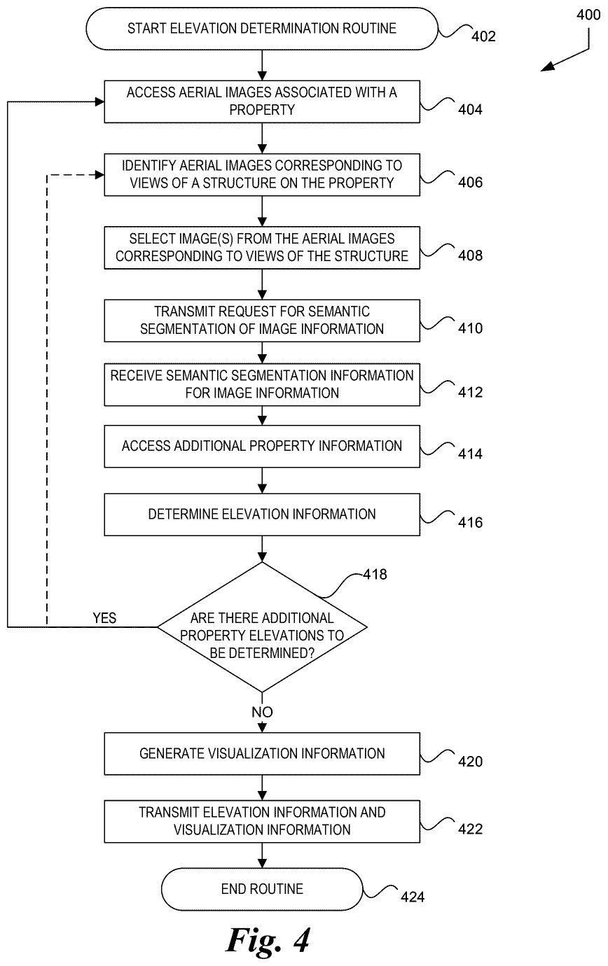

In some embodiments, at least a portion of the image information for the property may be provided by an aerial image system 160. For example, the mobile computing device 110 may provide an indication of a location where aerial image information is stored (e.g., with the request described above herein at (1)), or provide the aerial image information as part of a request to perform a flood risk assessment or first floor height determination. The use of aerial image information for first floor height determination is described in further detail with respect to FIG. 4 below herein.

At (4), the image segmentation system 120 performs semantic segmentation on image information provided by the flood risk assessment system 130 using a machine learning model. Semantic segmentation refers to the use of a machine learning model of the image segmentation system 120 associating a label with a portion of image information (e.g., a set of related pixels representing image information for an object or portion of an object), for example as metadata associated with the image information. The image segmentation system 120 semantically segments the image information to classify a portion of the image information as a property element. A property element may be, for example, a window, a door, siding, a stair, a set of stairs, a garage, a roof, a foundation, landscaping (e.g., a bush, a flower, a grassy area, etc.), or any other portion of the property that may be assigned a label. The machine learning model of the image segmentation system 120 may be a deep learning machine learning model trained to identify property elements, or visual elements generally, in image information and to generate a label for the identified elements. When the image segmentation system 120 has performed semantic segmentation on the image information, the labelled image information is transmitted from the image segmentation system 120 to the flood risk assessment system 130. The image segmentation system 120 may generate a plurality of image segments, where each image segment is associated with a label identifying an element represented by the image segment. Alternatively, the image segmentation system 120 may apply a plurality of labels to the image information received from the flood risk assessment system 130 and return the labelled image information to the flood risk assessment system 130.

Additionally, it should be noted that while semantically segmenting image information is shown here following the capture of depth and image information, in some embodiments capturing image information or depth information may occur in parallel with semantically segmenting image information. For example, semantic segmentation of first image information may occur while associated depth information is being captured. Further, while semantic segmentation is described here as being based on image information received from the mobile computing device 110, in embodiments where aerial image information is used, at least in part, to determine a first floor height, the image segmentation system 120 may semantically segment the aerial image information.

At (5), the flood risk assessment system 130 accesses additional property information for the property from an information system 260. The information system 260 may provide access to a property information data store 140 containing property information for at least one property. For example, the information system 260 may be a multiple listing service system storing property information for properties that have previously been, are currently, or that are expected to be listed for sale. In another example, the information system 260 may be associated with a state or federal government and provide public information such as elevation information for an area where the property is located. The additional property information may include elevation information, survey information from a previous survey of the property, image information, depth information, digital elevation model information, or any other information that may have previously been generated that is associated with the property and may be used to determine a floor height of a structure on the property.

At (6), the flood risk assessment system 130 determines the floor height for a structure on the property. The flood risk assessment system 130 may determine a height of the first occupied floor of the structure. The floor height may be determined based in part on the depth information and the image information for the property captured by the mobile computing device 110, the semantic segmentation information generated by the image segmentation system 120, or the additional property information the flood risk assessment system 130 accessed from the information system 260. The flood risk assessment system 130 may use the image information and the semantic segmentation information to identify the occupied floor closest to ground level. For example, the semantic segmentation information may include identification of a door. The flood risk assessment system 130 may then determine that the door is located on a portion of the structure closest to the ground level. In another example, the flood risk assessment system 130 may identify a plurality of windows on the structure based on the semantic segmentation information. Using the relative position of the identified windows within the image information, the flood risk assessment system 130 may determine that a first story of the structure is unoccupied while a second story of the structure is the occupied portion of the structure closest to ground level. When a portion of the structure is identified as being the lowest occupied floor of the structure, the flood risk assessment system 130 may then determine the height of the lowest occupied floor relative to ground level.

To determine the height of the lowest occupied floor, the flood risk assessment system 130 may associate the identified portion of the image information representing the lowest occupied floor of the structure with the depth information for the same area. To associate image and depth information for the same area, the flood risk assessment system 130 may use location information associated with each. The location information may be location information generated by the mobile computing device 110 when the depth information and the image information are captured. Where a portion of the image information or the depth information is accessed from an information system 260, the associated location information may not be in the same format as information generated by the mobile computing device 110. The flood risk assessment system 130 may then convert the location information for the information received from the information system 260 to the same format as the location information generated by the mobile computing device 110. Based on the combined image and depth information, the flood risk assessment system 130 may then determine the floor height of the lowest occupied floor of the structure. In some embodiments, the flood risk assessment system 130 may determine the height of additional floors of the structure. The flood risk assessment system 130 may then store or transmit the determined floor height. In some embodiments, a floor height of a structure may be determined based on aerial image information, as described in relation to FIG. 4 below herein.

The flood risk assessment system 130 may take various actions in response to determining the elevation of a floor of the structure. For example, the flood risk assessment system 130 may access a flood risk assessment form (e.g., a form used as part of a national flood insurance program) and complete at least a portion of the flood risk assessment form based on the determined elevation information for the structure. In a further example, the flood risk assessment system 130 may access historical water level information (e.g., stored in a property information data store 140) for an area including, or adjacent to, the property. The historical water level information includes one or more previously recorded water levels for the area. The flood risk assessment system 130 may determine that at least one of the previously recorded water levels is higher than the determined elevation for a floor or occupied portion of the structure. The flood risk assessment system 130 may, in response to determining a previously recorded water level exceeds an elevation for a floor or occupied portion of the structure transmit an alert. The alert may be transmitted to a property owner, an emergency service, an insurance provider, or any other interested party. In an additional example, the flood risk assessment system 130 may access a water level prediction (e.g., provided by a weather service) from a property information data store 140. The flood risk assessment system 130 may determine the predicted water level exceeds elevation information for at least a portion of the structure. In response, the flood risk assessment system 130 may transmit an alert to an emergency response service, a property owner, or other interested part, to indicate that flooding of at least a portion of the structure may occur.

### Example Interactive Floor Height Determination Routine

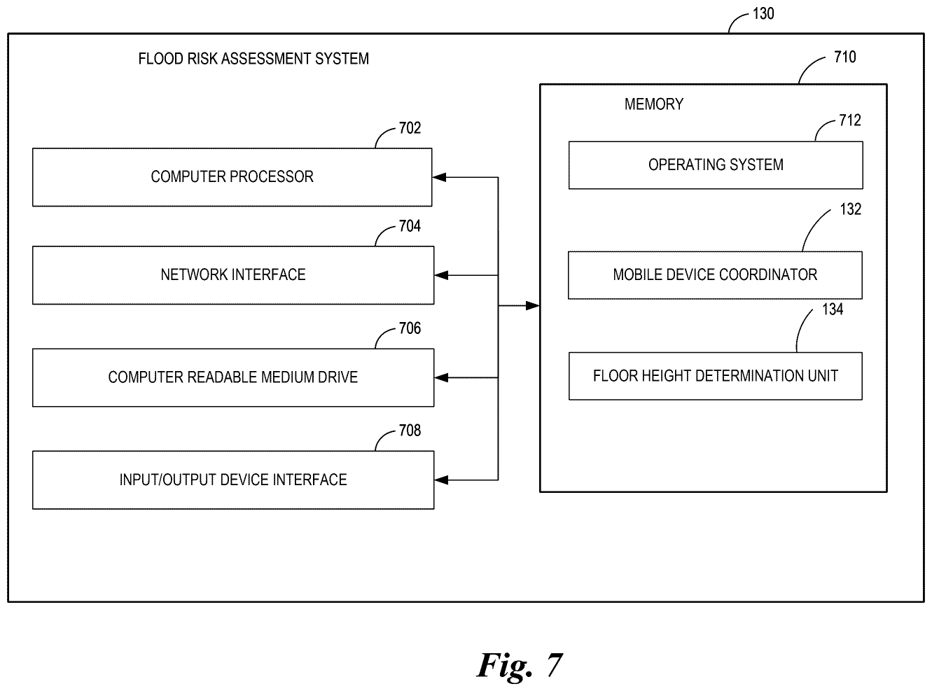

When a routine described herein (e.g., routines 300, 400, 500) is initiated, a set of executable program instructions stored on one or more non-transitory computer-readable media (e.g., hard drive, flash memory, removable media, etc.) may be loaded into memory (e.g., random access memory or RAM) of a computing device, such as the flood risk assessment system 130 shown in FIG. 7, and executed by one or more processors. In some embodiments, the routines 300, 400, 500, or portions thereof, may be implemented on multiple processors, serially or in parallel.

Routines described herein may refer, in part, to an order of operations, blocks, or steps. It should be understood that any reference to an order of the blocks of a routine is intended to aid in the explanation of the routine only, and does not imply that such an order is required for performing the operation described by the routine. Blocks of the routines described herein, therefore, should be understood to be capable of being performed before, after, and/or simultaneously with any other block of the routine. Additionally, various blocks of routines described herein may be performed repeatedly even where no loop is explicitly shown. Such loops may be excluded from the description of a routine for the purpose of clarity, and does not require that a block be performed only once before the routine proceeds. Further, some blocks shown in a routine herein may be optional, and therefore may be excluded in some implementations.

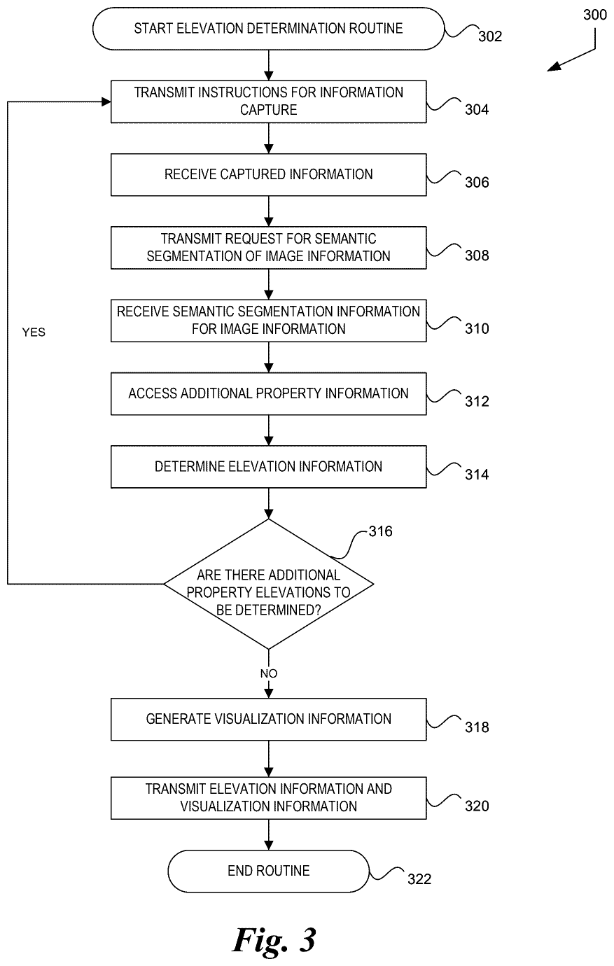

FIG. 3 illustrates example routine 300 for determining elevation information for a structure on a property. The elevation information may be used, for example, as part of a flood risk assessment for the structure. The routine 300 begins at block 302, for example in response to the flood risk assessment system 130 receiving a request to determine property elevation information for a property. The request may include the location of the property, the location of a structure on the property, the location of the mobile computing device 110 transmitting the request to the flood risk assessment system 130, or any additional information that may be useful in determining elevation information for the property.

At block 304, the flood risk assessment system 130 transmits instructions to the mobile computing device 110 guiding a user in the capturing of depth information and image information for the structure. The instructions may include an interactive graphical user interface (GUI) presented by the mobile computing device 110 to the user. The information to generate the GUI may be provided by the mobile device coordinator 132 to the user interface generator 114. The user interface generator 114 may then present the GUI to the user via an output (e.g., a display, a speaker, etc.) of the mobile computing device 110.

At block 306, the flood risk assessment system 130 receives the depth information and the image information for the structure from the mobile computing device 110. The depth information and the image information may be associated with location information indicating a location that the depth information and the image information represent. The location information may be information generated by a GPS system, an inertial motion unit, or another system of the mobile computing device 110 configured to generate location information.

At block 308, the flood risk assessment system 130 transmits a request to semantically segment the image information to the image segmentation system 120. The request may include the image information to be segmented, context for the image information (e.g., identifying the image information as representing a property), an identifier of the flood risk assessment system 130, or other information to cause the image segmentation system 120 to generate semantic segmentation information useful for determining a floor height of the structure.

At block 310, the flood risk assessment system 130 receives semantic segmentation information from the image segmentation system 120 for the image information. The semantic segmentation information may include labels associated with portions of the image information that indicate a classification or type of an object represented by the portion of the image information. The semantic segmentation information may include labels associated with elements of a structure (e.g., a window, door, pier, porch railing, etc.). In some embodiments, the semantic segmentation information may include divided portions of the image information, each portion associated with a label indicating the object or element of the structure represented by the portion. The divided portions may be related to each other by portion location information. The portion location information may indicate a relative position of each portion within the original image information, or an absolute position of the portion (e.g., based on GPS information, inertial measurement information, or image information).

At block 312, the flood risk assessment system 130 accesses additional information associated with the property or the structure stored in a property information data store 140. For example, the flood risk assessment system 130 may determine that an image of a portion of the structure is not useable (e.g., the image is out of focus, an obstruction is present in the image, etc.) to determine elevation information for the structure. In this example, the flood risk assessment system 130 may access additional image information for the structure, such as image information from a previous sales listing of the property stored in a multiple listing service database. Further examples of additional information include elevation information for the property, elevation information for the structure, planning documents for the property or the structure (e.g., documents filed with a county when requesting a work permit), a previous flood risk assessment or other information associated with the property or the structure.

At block 314, the flood risk assessment system 130 determines elevation information (e.g., local elevation (e.g., first floor relative to ground) or global elevation based on global position system (GPS) data for at least a portion (e.g., a first occupied floor) of the structure. Before identifying the elevation information, the flood risk assessment system 130 may have to identify the first occupied floor of the structure. The flood risk assessment system 130 may use the semantic segmentation information generated by the image segmentation system 120 to identify features of the structure that indicate a portion of the structure is occupied. For example, the semantic segmentation information may identify a window, vent (e.g., stove vent, dryer vent, air conditioner vent, etc.), siding, foundation, support post (e.g., a stilt of a stilted house), door, garage, light fixture, or other element of the structure that may indicate occupancy. The flood risk assessment system 130 may then use relative or absolute location information for the labelled portions of the image information to determine the first occupied floor of the structure.

In some embodiments, the owner or occupant of a structure may provide image information that includes the interior of the structure (e.g., the owner may take a picture that shows the interior of the structure through a window). In such embodiments, the interior information may be used to identify the first occupied floor of the structure. Alternatively, the owner or another user of the mobile computing device 110 may provide an indication of the first occupied floor of the structure. For example, the user may capture images of the structure, and then through the GUI provided by the mobile device coordinator 132 indicate the first occupied floor of the imaged structure (e.g., by circling the first occupied floor with the user's finger on a touchscreen display). When the first occupied floor has been identified, the flood risk assessment system 130 determines the elevation of the first occupied floor.

To determine the elevation of the first occupied floor, the flood risk assessment system 130 may combine the captured image information and depth information. For example, the flood risk assessment system 130 may overlay the image information on the depth information based on location information associated with each. This flood risk assessment system 130 may then identify the position of the first occupied floor within this combined image and depth information. The flood risk assessment system 130 may further identify the ground level nearest the first occupied floor in the combined image and depth information. Based on identifying the nearest ground level and the first occupied floor, the flood risk assessment system 130 may then use the depth information to determine a relative height of the first occupied floor to the ground by comparing the depth information for the bottom of the first occupied floor to the ground. Additionally, the flood risk assessment system 130 may use elevation information for the property to determine an absolute height of the first occupied floor (e.g., the height of the first occupied floor above sea level). In some embodiments, the flood risk assessment system 130 may use additional information for a body of water, such as a river, to determine a relative height between the first occupied floor and the body of water. In further embodiments, the flood risk assessment system 130 may use the combined image and depth information, or the elevation information for the area, to determine a grading of the ground surrounding the structure.

At decision block 316, the flood risk assessment system 130 determines whether there are additional property elevations to be determined. For example, the flood risk assessment system 130 may determine that a second structure is present in the image information received from the mobile computing device 110. If there is at least one additional property elevation to be determined, the routine 300 returns to block 304. In some embodiments, the routine 300 may instead return to a different block. For example, if depth and image data related to the additional elevation has already been received from the mobile computing device 110, the routine 300 may return to block 308. When no additional property elevations remain to be determined, the routine 300 moves to block 318.

At block 318, the flood risk assessment system 130 generates visualization information. The visualization information may, for example, include a labelled image that indicates the elevation of at least the first occupied floor of the structure. Alternatively, the visualization information may be a three-dimensional model of the structure, with a visual indication of the elevation of a portion of the model. The visualization information may be provided in an interactive format. For example, the flood risk assessment system 130 may transmit the visualization information as part of the GUI information to the user interface generator 114 to cause the mobile computing device 110 to display the visualization of the property and associated elevation information. In some embodiments, the visualization information may be stored by the flood risk assessment system 130 for later access. In some embodiments, the flood risk assessment system 130 may skip block 318 and the routine 300 may proceed to block 320.

At block 320, the flood risk assessment system 130 transmits the determined elevation information for the property, for example to the mobile computing device 110, property information data store 140, or the information system 260. In embodiments where the flood risk assessment system 130 generates visualization information, the flood risk assessment system 130 further transmits the visualization information. In some embodiments, the visualization information and the elevation information may be transmitted to different systems. When the flood risk assessment system 130 has transmitted the determined elevation information for the property, the routine 300 may move to block 322 and end.

FIG. 4 illustrates example routine 400 for determining elevation information for a structure on a property. The elevation information may be used, for example, as part of a flood risk assessment for the structure. The routine 400 begins at block 402, for example in response to the flood risk assessment system 130 receiving a request to determine property elevation information for a property, or a structure on a property. The request may include the location of the property, the location of a structure on the property, the location of the mobile computing device 110 transmitting the request to the flood risk assessment system 130, or any additional information that may be useful in determining the structure or structures for which elevation information is to be determined.

At block 404, the flood risk assessment system 130 accesses aerial image information associated with a property. For example, the flood risk assessment system 130 may transmit a request to the aerial image system 160 for aerial images of the property, access the property information data store 140 where aerial images for the property may be stored, or receive aerial images from the mobile computing device 110 (e.g., where the mobile computing device 110 is used to control an aerial imaging drone or is used to store aerial images of the property from another source). In some embodiments, aerial images may include, or be associated with, information in addition to the image information. For example, metadata associated with an aerial image, or other information associated with the aerial image, may indicate a position of the camera used to capture the aerial image, information for at least one degree of freedom for the camera (e.g., degree of freedom information corresponding to pitch, yaw, or roll values of a gimbal to which the camera is attached, the surge, heave, or sway values of the camera relative to a position on an aerial vehicle, etc.), a camera type, an image sensor type, an image resolution, an aerial vehicle type, a camera speed or velocity relative to a ground position, or other information related to the aerial camera or the image.

At block 406, the flood risk assessment system 130 identifies aerial images corresponding to views of a structure on a property from the received aerial image information. In some embodiments, the flood risk assessment system 130 may analyze an aerial image to determine whether at least a portion of a structure is present in the image. In further embodiments, aerial images may be associated with a label indicating that the aerial image includes a view of a structure. A label associated with an aerial image may further indicate that the aerial image represents a particular view of the structure (e.g., a facing of the structure such as a north-east facing is included in the aerial image, a facing of the structure including a main entrance is included, etc.). In additional embodiments, the flood risk assessment system 130 may identify aerial images based on position information associated with where the aerial image was generated. Images may further be identified based on degree of freedom information associated with an aerial image, a time of generation of an aerial image, or other information associated with the aerial image.

At block 408, In some embodiments, the flood risk assessment system 130 may select a fixed number (e.g., 2, 4, 5, 12, etc.) of aerial images for use in determining a first floor height for a structure. For example, the flood risk assessment system 130 may select four aerial images corresponding to different views of the structure. The flood risk assessment system 130 may determine whether the selected four aerial images, in this example, correspond to different views of the structure based on position information, degree of freedom information, or other information or associated with the aerial images. The flood risk assessment system 130 in this example may select the four aerial images so that each image of the four aerial images corresponds to a different cardinal direction (e.g., North, South, East, or West). The flood risk assessment system 130 in this example may alternatively select the four aerial images such that pairs of aerial images in the four aerial images are captured from substantially opposing viewpoints, and such that a line connecting the location of each image in a pair of images is substantially perpendicular to a line connecting the location of each image in a second pair of images (e.g., a first pair of aerial images captured at 45° NNW and 45° SSE, and a second pair of images captured at 42° NNE and 47° SSW relative to a structure for which a first floor height is to be determined).

In some embodiments, the flood risk assessment system 130 may select a plurality of aerial images that include a similar viewpoint (e.g., two or more images including a north-facing view of a structure, two or more images associated with aerial image information indicating the aerial images were generated when an image sensor was facing a same portion of a structure, etc.). Aerial images in such embodiments may be grouped based on position information, or other information, associated with the plurality of aerial images to generate a set of aerial images for a similar viewpoint. Multiple sets of aerial images, each set of aerial images associated with a different similar viewpoint, may be generated by the flood risk assessment system 130. Further, in some embodiments at least one aerial image from the plurality of aerial images associated with a similar viewpoint may be selected following semantic segmentation of the images, for example based on an aerial image including a highest number of identified elements for a viewpoint. Segmentation of an aerial image is discussed further at blocks 410-412 below.

At block 410, the flood risk assessment system 130 transmits a request to semantically segment the aerial image information to the image segmentation system 120. The request may include the image information to be segmented, context for the image information (e.g., identifying the image information as representing a property), an identifier of the flood risk assessment system 130, or other information to cause the image segmentation system 120 to generate semantic segmentation information useful for determining a floor height of the structure (e.g., identifying elements of the structure such as a window, a pier, a door, a porch railing, etc.).

At block 412, the flood risk assessment system 130 receives semantic segmentation information from the image segmentation system 120 for the aerial image information. The semantic segmentation information may include labels associated with portions of the aerial image information that indicate a classification or type of an object represented by the portion of the aerial image information. The semantic segmentation information may include labels associated with elements of a structure (e.g., a window, door, pier, porch railing, etc.). In some embodiments, the semantic segmentation information may include divided portions of the aerial image information, each portion associated with a label indicating the object or element of the structure represented by the portion. The divided portions may be related to each other by portion location information. The portion location information may indicate a relative position of each portion within the original aerial image information, or an absolute position of the portion (e.g., based on GPS information, inertial measurement information, or aerial image information).

At block 414, the flood risk assessment system 130 accesses additional information associated with the property or the structure stored in a property information data store 140. For example, the flood risk assessment system 130 may determine that an aerial image of a portion of the structure is not useable (e.g., the image is out of focus, an obstruction is present in the image, etc.) to determine elevation information for the structure. In this example, the flood risk assessment system 130 may access additional aerial image information for the structure, such as another aerial image associated with a similar view as discussed above with respect to block 408. Further examples of additional information include elevation information for the property (e.g., a portion of a digital elevation model), elevation information for the structure, planning documents for the property or the structure (e.g., documents filed with a county when requesting a work permit), a previous flood risk assessment or other information associated with the property or the structure.

At block 416, the elevation determination unit 134 of the flood risk assessment system 130 determines elevation information (e.g., local elevation (e.g., first floor relative to ground) or global elevation based on global position system (GPS) data) for at least a portion (e.g., a first occupied floor) of the structure. The flood risk assessment system 130 may use the semantic segmentation information generated by the image segmentation system 120 to identify features of the structure that indicate a portion of the structure is occupied. For example, the semantic segmentation information may identify a window, vent (e.g., stove vent, dryer vent, air conditioner vent, etc.), siding, foundation, support post (e.g., a stilt of a stilted house), door, garage, light fixture, or other element of the structure that may indicate occupancy. The flood risk assessment system 130 may then use relative or absolute location information for the labelled portions of the image information to determine the first occupied floor of the structure.

In some embodiments, the owner or occupant of a structure may provide image information that includes the interior of the structure (e.g., the owner may take a picture that shows the interior of the structure through a window). In such embodiments, the interior information may be used to identify the first occupied floor of the structure. Alternatively, the owner or another user of the mobile computing device 110 may provide an indication of the first occupied floor of the structure. For example, a user may indicate through a GUI provided by the mobile device coordinator 132 the first occupied floor of the imaged structure (e.g., by circling the first occupied floor with the user's finger on a touchscreen display). In additional embodiments, the flood risk assessment system 130 may determine the first occupied floor based on the location of elements of the structure identified by semantic segmentation, and based on a common, or average, location of such elements in similar structures (e.g., single family homes, apartment buildings, townhomes, three story structures, single story structures, etc.). Determining a common location of elements in a similar structure may be based on information associated with a plurality of similar structures, building code information, planning documents (e.g., building permit information), or other information that may be accessed by the flood risk assessment system 130 (e.g., at block 414 above).

To determine the elevation of the first occupied floor of a structure, the flood risk assessment system 130 may determine, for each aerial image used to determine the election of the first occupied floor, elements of the structure identified by semantic segmentation of the aerial images. For example, when four aerial images are used the flood risk assessment system 130 may determine, based on the semantic segmentation information associated with a first aerial image, that the first aerial image includes a door, a window, and a porch railing. In this example, a second aerial image may be determined, based on the semantic segmentation information, to include a first pier, a second pier, and a window. The third and fourth aerial images may be similarly determined to include various elements of the structure based on the semantic segmentation information. In this example, the relative height (e.g., relative to a point on the structure, relative to a point on the ground surrounding the structure, etc.) of the bottom of the door, window, and porch railing in the first aerial image, and the first and second piers, and the window, in the second aerial image may be determined (e.g., based on photogrammetry applied to the aerial image).

When multiple elements of a structure are present in the aerial images from which a first floor height will be determined, as in the previous example, the flood risk assessment system 130 may prioritize elements of the structure that will be used to determine the first floor height (e.g., as a hierarchy of structural elements). The priority of an element for use in determining first floor height may be based, for example, on a consistency of the location of the element across structures, the likelihood an element will be present on a structure, the reliability of identifying an element by semantic segmentation, the association of an element with a building code or other regulation that would generally require a similar position of the element on different structures, or an input provided by a user of the flood risk assessment system 130. In embodiments where multiple instances of a same element (e.g., windows, porch railings, etc.) are identified as being present on the structure, and the same element is the element most likely to be useful in indicating the first floor height of a structure. In such embodiments, the flood risk assessment system 130 may determine that the element with the lowest relative height, or the highest relative height, is to be used from among the same elements.

Continuing the previous example with four aerial images, the flood risk assessment system 130 may first identify the door, window, or porch railing having a lowest relative height, and the pier having a highest relative height. The flood risk assessment system 130 may then determine that, based on a hierarchy of elements, the relative height of a pier is to be used to determine the first floor height. The flood risk assessment system 130 of this example may then determine that the second pier has a highest relative height when compared to the first pier, and use the relative height of the second pier in determining the first floor height of the structure.

When an element of the structure has been selected from which the first floor height will be determined, the location of the element (e.g., the relative height of the element) is compared to a digital elevation model or other geospatial information for the property in order to determine an absolute height of the element. For example, the flood risk assessment system 130 may align the aerial images with the digital elevation model such that the position of elements of the structure represented in the aerial images is aligned with their positions in the digital elevation model. Based on the absolute height of the element, and information used to determine the height of a first floor based on the element, the absolute height of the first floor is determined. The flood risk assessment system 130 may then determine a lowest adjacent grade of the property surrounding the structure. The determined lowest adjacent grade may be compared to the absolute height of the first floor that has been determined to generate a final first floor height for the structure relative to the lowest adjacent grade.

In some embodiments, aerial image information from two or more aerial images may include at least a portion of the same element. The flood risk assessment system 130 may then identify the portions of the element in the two or more aerial images as being associated with the same element (e.g., based on position information, or other information associated with the image). The flood risk assessment system 130 may then determine a height for the same element based on each aerial image to determine whether the two or more height values are the same. Where the two or more height values are the same, or within a threshold distance of each other, the flood risk assessment system 130 may proceed as described above. Alternatively, where the two or more height values are different, the flood risk assessment system 130 may discard the element from use in determining the first floor height, select a largest height value for the same element, select a lowest height value for the same element, determine an average height value for the same element, compare each height value to other information associated with the property or structure to determine a most likely correct height value (e.g., based on structural diagrams, planning documents, permit information, or other information accessed by the flood risk assessment system 130), or otherwise select between the different height values for the same element.

In additional embodiments, semantic segmentation of an aerial image may identify a non-structure element (e.g., a bush, separate air conditioning unit, tree, or other element of the property not part of the structure being analyzed). The flood risk assessment system 130 may then determine whether the non-structure element obscures at least a portion of an element of the structure. Where the non-structure element obscures at least a portion of an element of the structure, the flood risk assessment system 130 may determine to not use the obstructed element when determining a first floor height for the structure.

At decision block 418, the flood risk assessment system 130 determines whether there are additional property elevations (e.g., first floor height of a second structure) to be determined. For example, the flood risk assessment system 130 may determine that a second structure is present in at least a portion of the received aerial image information (e.g., one of ten aerial images accessed from the aerial image system 160), or may have received a request to determine a first floor height for a second structure. If there is at least one additional property elevation to be determined, the routine 400 may return to block 404 to access additional aerial images associated with the property, or block 406 to identify previously-accessed aerial images corresponding to views of the second structure. In some embodiments, the routine 400 may instead return to a different block. For example, if aerial images associated with a second structure were identified previously when identifying aerial images associated with the first structure, the routine 400 may return to block 408. When no additional property elevations remain to be determined, the routine 400 moves to block 420.

At block 420, the flood risk assessment system 130 generates visualization information. The visualization information may, for example, include a labelled image that indicates the elevation of at least the first occupied floor of the structure. Alternatively, the visualization information may be a three-dimensional model of the structure, with a visual indication of the elevation of a portion of the model. The visualization information may be provided in an interactive format. For example, the flood risk assessment system 130 may transmit the visualization information as part of the GUI information to the user interface generator 114 to cause the mobile computing device 110 to display the visualization of the property and associated elevation information. In some embodiments, the visualization information may be stored by the flood risk assessment system 130 for later access. In some embodiments, the flood risk assessment system 130 may skip block 418 and the routine 300 may proceed to block 420.

At block 422, the flood risk assessment system 130 transmits the determined elevation information for the property, for example to the mobile computing device 110, property information data store 140, or the information system 260. In embodiments where the flood risk assessment system 130 generates visualization information, the flood risk assessment system 130 further transmits the visualization information. In some embodiments, the visualization information and the elevation information may be transmitted to different systems. When the flood risk assessment system 130 has transmitted the generated visualization information or elevation information, the routine 400 moves to block 424 and ends.

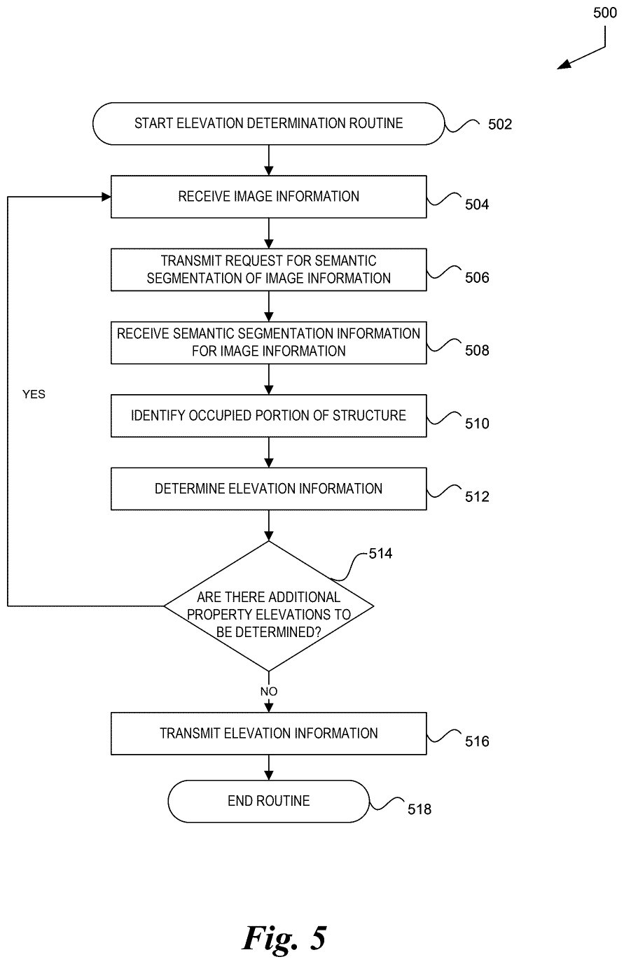

FIG. 5 illustrates example routine 500 for determining elevation information for a structure on a property. The elevation information may be used, for example, as part of a flood risk assessment for the structure. The routine 500 begins at block 502, for example in response to the flood risk assessment system 130 receiving a request to determine elevation information for a property. The request may include the location of the property, the location of a structure on the property, the location of the mobile computing device 110 transmitting the request to the flood risk assessment system 130, or any additional information that may be useful in determining elevation information for the property.

At block 504, the flood risk assessment system 130 receives image information from an image information source. For example, an image information source may be an aerial image system 160 (e.g., as described with respect to block 404 of the routine 400 above herein. In another example, a mobile computing device 110 (e.g., as described with respect to block 306 of the routine 300 above herein). In a further example, an image information source may be a property information data store 140 or other storage location where image information associated with a property or structure is stored.

At block 506, the flood risk assessment system 130 transmits a request for semantic segmentation of image information to the image segmentation system 120, for example as described with respect to block 308 of routine 300 or block 410 of routine 400 above herein.

At block 508, the flood risk assessment system 130 receives semantic segmentation information from the image segmentation system 120, for example as described with respect to block 310 of routine 300 or block 412 of routine 400 above herein.

At block 510, the flood risk assessment system 130 identifies an occupied portion of the structure. The occupied portion may be identified based on the semantic segmentation information. In some embodiments, a window, vent, or other feature of the structure identified in the semantic segmentation information may indicate that a portion of the structure is occupied. In some embodiments, image information, depth or elevation information, or other information (e.g., accessed from a property information data store 140) may be used, alone or in combination, by the flood risk assessment system 130 to identify an occupied portion of the structure. For example, the flood risk assessment system 130 may analyze at least a portion of the semantic segmentation information and associated image information to identify a lowest window of the structure. The flood risk assessment system 130 in this example may then indicate to the flood risk assessment system 130 that a portion of the structure associated with the window is occupied. Further, in this example, the flood risk assessment system 130 may determine that portions of the structure above the identified lowest window are likely to be occupied. A similar analysis to the previous example may be used to identify occupied portions of a structure based on other elements of the structure. Additionally, the occupied portion of a structure identified by the flood risk assessment system 130 may be different from the lowest occupied portion of the structure. For example, a first floor location and second floor location of a structure may be identified by the flood risk assessment system 130 based on features of the structure to determine a ceiling height of the first floor of the structure.

At block 512, the elevation determination unit 134 of the flood risk assessment system 130 determines elevation information (e.g., local elevation (e.g., first floor relative to ground) or global elevation based on global position system (GPS) data) for at least a portion (e.g., a first occupied floor) of the structure, for example as described with respect to block 416 of routine 400, or block 314 of routine 300 above herein.

At decision block 514, the flood risk assessment system 130 determines whether there are additional property elevations to be determined. If there are remaining property elevations to be determined, the routine 500 may return to block 504, or any previous block of the 500. If there are no remaining property elevations to be determined, the routine 500 moves to block 516.

At block 516, the flood risk assessment system 130 transmits the determined elevation information for the property, for example to the mobile computing device 110, property information data store 140, or the information system 260. In embodiments where the flood risk assessment system 130 generates visualization information, the flood risk assessment system 130 further transmits the visualization information. In some embodiments, the visualization information and the elevation information may be transmitted to different systems. When the flood risk assessment system 130 has transmitted the generated visualization information or elevation information, the routine 500 moves to block 518 and ends.

### Example Building Structure

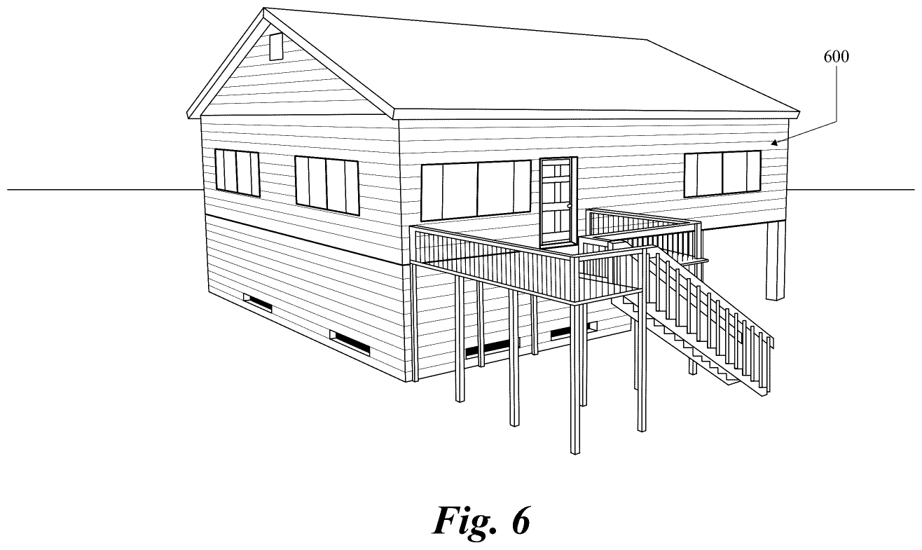

FIG. 6 illustrates an example structure 600 on a property for which a first floor elevation may be determined according to the description above herein. The structure 600 is a two-story building. The first story of the example structure 600 is partially enclosed, as shown by the portion having siding and multiple vents. Further, the second story of the structure 600 is partially supported by posts, or stilts, of an open section of the first story. The entrance to the structure 600 is located on the second story, with a staircase bypassing the first story to allow access to the structure 600 at the second story. In an example use of the flood risk assessment system 130 a home owner, real estate agent, surveyor, insurer, or other user may send a request to the flood risk assessment system 130 to determine elevation information for the structure 600.

In response to the request, flood risk assessment system 130 may provide instructions to a mobile computing device 110 of the user, guiding the user in capturing information (e.g., depth information or image information) for use by the flood risk assessment system 130. The instructions may be provided, for example, via a GUI. The user may follow the instructions to use a first sensor of a first sensor type (e.g., LIDAR, stereo depth, structure light, time of flight, etc.) to capture depth information for portions of the structure. For example, the user may be concerned with determining elevation for the first story of the structure 600, and capture depth information for the first story. Alternatively, the user may intend to determine elevation information for the first and second story of the structure 600, and the instructions may then direct the user in capturing depth information for at least the first and second story of the building. In some embodiments, depth information for more than the portion of the structure for which elevation information will be determined may be captured and use by the flood risk assessment system 130. Further, the depth information may include location information for the mobile phone to assist in determining the relative location of areas for which depth information is captured (e.g., the depth information of a first portion of the structure 600 captured at a first location and depth information for a second portion of the structure captured at a second location).

The user may also follow the instructions to use a second sensor of a second sensor type (e.g., CMOS, CCD, etc.) to capture image information for the structure 600. Following the examples described above, the user may capture image information for at least a portion of the structure 600 that elevation information the flood risk assessment system 130 will generate elevation information for. The flood risk assessment system 130 receives the captured image information and captured depth information from the mobile computing device 110. The flood risk assessment system 130 may then retrieve additional property information useful for determining elevation information for the structure 600. For example, the flood risk assessment system 130 may retrieve elevation maps for an area where the property is located, existing image information for the property (e.g., from a multiple listing service, online map, etc.), aerial images for the property, and the like.

Further, the flood risk assessment system 130 in this example transmits at least a portion of the image information to an image segmentation system 120 and in response receives semantically segmented image information. The semantically segmented image information of the structure 600 in this example may include labelled image information for the vents located along the lower part of the first story, the entrance and windows located on the second story, the support posts located in the uncovered portion of the first story, the staircase, and the roof.

Using the semantically segmented image information, the flood risk assessment system 130 in this example identifies the lowest occupied floor of the structure 600. For example, the flood risk assessment system 130 may determine based on the presence of the vents along the lower part of the first story, and the location of the vents, that the first story is likely not to be occupied. Further, the flood risk assessment system 130 may determine that the second story is likely to be occupied, for example, based on the semantically segmented image information indicating the presence of windows, or the entrance.

Based on the second story being the lowest occupied floor of the structure, the flood risk assessment system 130 determines the elevation of the second story. The flood risk assessment system 130 may use a portion of the depth information to determine the elevation information for the second story of the structure 600. The flood risk assessment system 130 may in some embodiments additionally use a portion of at least one of the semantically segmented image information, or the image information to determine the elevation of the second story of the structure 600. For example, the flood risk assessment system 130 may use the semantically segmented image information to locate the bottom of the second story. The flood risk assessment system 130 may then identify depth information associated with the location of the bottom of the second story and depth information for the highest elevation of ground relative to the bottom of the second story. The flood risk assessment system 130 may then determine the elevation of the second story based on the difference in depth information for the second story and the ground.

When the flood risk assessment system 130 has determined at least the elevation of the second story of the structure 600, the flood risk assessment system 130 in this example may transmit the elevation information to the mobile computing device 110. In some embodiments, the flood risk assessment system 130 may generate a three-dimensional image of the structure 600 based on the image information and the depth information. The three-dimensional image may include a label indicating the elevation of the second story, or any other elevation determined by the flood risk assessment system 130. In further embodiments, the flood risk assessment system 130 may provide the three-dimensional image through a GUI allowing the user to rotate the three-dimensional image (e.g., using a touchscreen, mouse, keyboard, or other control method) from a first view to a second view. The second view may display elevation information (e.g., as a label) for a portion of the structure 600 not shown in the first view. For example, the first view may be of the rear of the structure 600, and a label indicating the elevation of the second story may be shown. The second view in this example may show the staircase, and a label for the elevation of the upper landing of the staircase. In additional embodiments, the flood risk assessment system 130 may complete a flood risk assessment form based on the elevation information for a story of the structure 600. The flood risk assessment system 130 may further use the additional property information accessed previously to complete the flood risk assessment form.

### Execution Environment

FIG. 7 illustrates various components of an example flood risk assessment system 130 configured to implement various functionality described herein.

In some embodiments, the flood risk assessment system 130 may be implemented using any of a variety of computing devices, such as server computing devices, desktop computing devices, personal computing devices, mobile computing devices, mainframe computing devices, midrange computing devices, host computing devices, or some combination thereof.

In some embodiments, the features and services provided by the flood risk assessment system 130 may be implemented as web services consumable via one or more communication networks. In further embodiments, the flood risk assessment system 130 is provided by one or more virtual machines implemented in a hosted computing environment. The hosted computing environment may include one or more rapidly provisioned and released computing resources, such as computing devices, networking devices, and/or storage devices. A hosted computing environment may also be referred to as a “cloud” computing environment

In some embodiments, as shown, a flood risk assessment system 130 may include: one or more computer processors 702, such as physical central processing units (“CPUs”); one or more network interfaces 704, such as a network interface cards (“NICs”); one or more computer readable medium drives 706, such as a high density disk (“HDDs”), solid state drives (“SSDs”), flash drives, and/or other persistent non-transitory computer readable media; one or more input/output device interfaces 708; and one or more computer-readable memories 710, such as random access memory (“RAM”) and/or other volatile non-transitory computer readable media.

The computer-readable memory 710 may include computer program instructions that one or more computer processors 702 execute and/or data that the one or more computer processors 702 use in order to implement one or more embodiments. For example, the computer-readable memory 710 can store an operating system 712 to provide general administration of the flood risk assessment system 130. As another example, the computer readable memory 710 can store a mobile device coordinator 132. As another example, the computer-readable memory 710 can store a elevation determination unit 134.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design conditions imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

1. A computer-implemented method comprising:
accessing aerial image information comprising an aerial image associated with a property;
applying the aerial image as input to a machine learning model to cause the machine learning model to generate semantic segmentation image information, wherein the machine learning model is configured to perform semantic segmentation on image information;
identifying an occupied portion of a structure located on the property based on the semantic segmentation image information;
determining elevation information for the occupied portion of the structure based on an element of the structure identified in the semantic segmentation image information and the aerial image information; and
storing the elevation information.

2. The computer-implemented method of claim 1, wherein the aerial image information comprises a plurality of aerial images, and wherein the computer-implemented method further comprises:
selecting, from the aerial image information, the aerial image based on the aerial image comprising a view of at least a portion of the structure.

3. The computer-implemented method of claim 1, wherein the aerial image information comprises a plurality of aerial images, and wherein the computer-implemented method further comprises:
identifying a set of aerial images from the plurality of aerial images comprising a view of at least a portion of the structure;
selecting the aerial image from the set of aerial images based on a first view of the structure in the aerial image;
selecting a second aerial image from the set of aerial images based on a second view of the structure in the second aerial image, wherein the second view is different from the first view;
applying the second aerial image as input to a machine learning model to cause the machine learning model to generate second semantic segmentation image information, wherein the machine learning model is configured to perform semantic segmentation on image information;
determining second elevation information for the occupied portion of the structure based on a second element of the structure identified in the second semantic segmentation image information; and
determining that the elevation information is more likely to be correct than the second elevation information.

4. The computer-implemented method of claim 3, wherein determining that the elevation information is more likely to be correct than the second elevation information comprises:
determining an element type of the element;
determining a second element type of the second element; and
comparing the element type and the second element type to a hierarchy of element types to determine the element type is associated with a higher confidence than the second element type.

5. The computer-implemented method of claim 3, wherein the first view is associated with a first cardinal direction, and wherein selecting the second aerial image from the set of aerial images is further based on the second view being associated with a second cardinal direction different than the first cardinal direction.

6. The computer-implemented method of claim 3, wherein the aerial image information comprises camera information associated with each image of the plurality of aerial images, and wherein a direction of the first view is determined based on the camera information.

7. The computer-implemented method of claim 6, wherein the camera information comprises at least one of: degree of freedom information associated with a camera used to generate the aerial image at a time the aerial image was generated, or location information for an aerial vehicle used to generate the aerial image at the time the aerial image was generated.

8. The computer-implemented method of claim 1, wherein the semantic segmentation image information comprises identification of the element as associated with a first element type, wherein the semantic segmentation information comprises identification of a second element associated with a second element type, and wherein the computer-implemented method further comprises:
comparing the first element type and the second element type to a hierarchy of element types to determine the first element type is preferred for use in determining elevation information.

9. The computer-implemented method of claim 1, wherein the semantic segmentation image information comprises identification of the element as associated with a first element type, wherein the semantic segmentation information comprises identification of a second element as associated with a second element type, wherein the first element type is the same element type as the second element type, and wherein the computer-implemented method further comprises:
determining a first elevation of a lowest edge of the first element;
determining a second elevation of a lowest edge of the second element;
comparing the first elevation to the second elevation to determine the first elevation is lower than the second elevation; and
based on the first elevation being lower than the second elevation, selecting the element for use in determining elevation information for the occupied portion of the structure.

10. The computer-implemented method of claim 1, wherein the semantic segmentation image information comprises identification of the element as associated with a first element type, wherein the semantic segmentation information comprises identification of a second element as associated with a second element type, wherein the first element type is the same element type as the second element type, and wherein the computer-implemented method further comprises:
determining a first elevation of a lowest edge of the first element;
determining a second elevation of a lowest edge of the second element;
comparing the first elevation to the second elevation to determine the first elevation is higher than the second elevation; and
based on the first elevation being higher than the second elevation, selecting the element for use in determining elevation information for the occupied portion of the structure.

11. (canceled)

12. (canceled)

13. (canceled)

14. (canceled)

15. (canceled)

16. (canceled)

17. (canceled)

18. (canceled)

19. (canceled)

20. (canceled)

21. A computer-implemented method comprising:
receiving image information associated with a property;
applying the image information as input to a machine learning model to cause the machine learning model to generate semantic segmentation image information, wherein the machine learning model is configured to perform semantic segmentation on image information;
identifying an occupied portion of a structure associated with the property based on the semantic segmentation image information;
determining elevation information for the occupied portion of the structure based on the image information; and
storing the elevation information.

22. The computer-implemented method of claim 21, wherein the image information is aerial image information comprising an aerial image associated with the property, and wherein the computer-implemented method further comprises accessing the aerial image information.

23. The computer-implemented method of claim 21, wherein the image information is captured by a first sensor type, wherein determining the elevation information is further based on depth information, and wherein the computer-implemented method further comprises:
receiving the depth information associated with the property captured by a second sensor type.
